(19) United States
(12) Patent Application Publication
(10) Pub. No.: US 2024/0091791 A1
(43) Pub. Date: Mar. 21, 2024

(54) CENTRIFUGAL SEPARATOR

(71) Applicant: Alfdex AB, LANDSKRONA (SE)

(72) Inventor: Anders ÖRTEGREN, Landskrona (SE)

(73) Assignee: Alfdex AB, LANDSKRONA (SE)

(21) Appl. No.: 18/038,538

(22) PCT Filed: Nov. 22, 2021
(86) PCT No.: PCT/EP2021/082421

§ 371 Date: May 24, 2023

(30) Foreign Application Priority Data
Dec. 18, 2020 (EP) 20215439.9

(51) Int. Cl. B04B 11/02; B04B 5/12

(52) U.S. Cl. CPC B04B 11/02; B04B 5/12; B04B 2005/125

(57) ABSTRACT

A centrifugal separator for separating a liquid phase from a crankcase gas includes a housing, a separation chamber inside the housing, a rotor shaft, a rotor connected to the rotor shaft, a bearing arranged at an end portion of the rotor shaft, and a liquid outlet for the separated liquid phase. The end portion of the rotor shaft extends through the bearing outside the separation chamber. A ring-shaped sealing gap is formed between the housing and a member connected to the rotor shaft outside the separation chamber. The liquid outlet is arranged, seen in relation to the axial direction, radially outside the bearing and radially inside a radially outer end of the ring-shaped sealing gap.

### TECHNICAL FIELD

The present invention relates to a centrifugal separator for separating a liquid phase from a crankcase gas.

### BACKGROUND

Crankcase gas from an internal combustion engine is ventilated from a crankcase of a relevant combustion engine. Crankcase gases may be disposed of in an environmentally friendly manner instead of being ventilated in untreated form to the atmosphere. For certain types of combustion engines, legislation requires crankcase gases to be disposed of in an environmentally friendly manner.

Crankcase gases may comprise inter alia blow-by gases, oil, other liquid hydrocarbons, soot, and other solid combustion residues. In order to dispose of crankcase gases suitably, the gas is separated from oil, soot, and other residues. The separated gas may be led to an air intake of the combustion engine or vented to the atmosphere, and the oil may be led back to an oil sump of the combustion engine optionally, via an oil filter for removing soot and other solid residues from the oil.

A centrifugal separator may be used for disposing of crankcase gas. The crankcase gas is led into a rotor of the centrifugal separator and heavy constituents of the crankcase gases, such as oil and soot, are separated as a liquid phase from a cleaned gas. The liquid phase is led out of the centrifugal separator via a liquid outlet. The cleaned gas is lead out of the centrifugal separator via a gas outlet.

WO 2016/198274 discloses a centrifugal separator for separating crankcase gas, a liquid passage from a separation chamber is provided via a ball bearing of a rotor shaft.

### SUMMARY

Soot and other solid particles carried by the liquid phase through a bearing may damage the bearing and thus, may shorten the life span of the bearing and the centrifugal separator.

It would be advantageous to achieve a centrifugal separator overcoming, or at least alleviating, the above-mentioned drawback. In particular, it would be desirable to ensure a durable centrifugal separator for separating a liquid phase from crankcase gas with an expected rotor shaft bearing lifespan to be maintained. To address this and other concerns, a centrifugal separator having the features defined in the independent claim is provided.

According to an aspect, there is provided a centrifugal separator for separating a liquid phase from a crankcase gas as defined in claim 1. The centrifugal separator comprises: a housing, a separation chamber inside the housing, a rotor shaft extending through the separation chamber in an axial direction, a rotor for separating the liquid phase arranged inside the separation chamber and connected to the rotor shaft, a bearing arranged at an end portion of the rotor shaft, an inlet for the crankcase gas, a gas outlet from the separation chamber for separated gas, and a liquid outlet from the separation chamber for the separated liquid phase. The rotor shaft is journalled in the housing via the bearing. The end portion of the rotor shaft extends through the bearing outside the separation chamber. A ring-shaped sealing gap is formed between the housing and a member connected to the rotor shaft outside the separation chamber, and the liquid outlet is arranged, seen in relation to the axial direction, radially outside the bearing and radially inside a radially outer end of the ring-shaped sealing gap.

Since the liquid outlet is arranged radially outside the bearing, during use of the centrifugal separator it is avoided that all of the separated liquid phase will reach and flow through the bearing. Thus, at least a main portion of the liquid phase with particles contained therein will flow through the liquid outlet arrange radially outside and separate from the bearing. Accordingly, it is avoided, at least to a large extent, that the liquid phase with the particles reaches the bearing. Thus, the risk of the particles causing wear of the bearing is reduced. Moreover, since the liquid outlet also is arranged radially inside a radially outer end of the ring-shaped sealing gap, the liquid phase is provided via the liquid outlet into the sealing gap. Thus, the sealing function of the sealing gap is improved by the liquid phase flowing through the sealing gap during use of the centrifugal separator. More specifically, at the bearing, a gas pressure within the separation chamber is sealed from a gas pressure outside the separation chamber by the sealing gap. Separated liquid phase in the sealing gap contributes to the sealing function of the sealing gap. Thus, with the liquid outlet arranged according radially outside the bearing but inside a radially outer end of the ring-shaped sealing gap, not all of the separated liquid phase will flow through the bearing and at the same time the sealing function of the sealing gap will be improved by the liquid phase flowing through the sealing gap during use.

It has been realised by the inventor that solid particles separated with a liquid phase from combustion gas may cause wear on a bearing of a centrifugal separator to such an extent that a lifespan of the bearing is shortened in comparison with its expected lifespan.

The centrifugal separator is arranged for cleaning crankcase gas from an internal combustion engine, ICE. Such an ICE may be configured for propelling a vehicle or may be a stationary combustion engine, for instance for driving a generator for generating an electrical current.

The crankcase gas, also referred to as blow-by gas, may be ventilated from the crankcase of the ICE via a crankcase ventilation system. The centrifugal separator may form part of the crankcase ventilation system.

The crankcase gas is the result of the high pressure within the cylinders of the ICE forcing some of the combustion gas and liquid and solid residues past the piston rings down into the crankcase of the ICE. If not ventilated, an increased pressure within the crankcase may cause engine oil to leak out of the ICE and the liquid and solid residues may contaminate and/or dilute the engine oil.

The centrifugal separator is configured to separate heavy constituents of the crankcase gas, such as oil, other liquid hydrocarbons, soot, and other solid combustion residues from the crankcase gas as the liquid phase.

In operation of the centrifugal separator, crankcase gas is led into the separation chamber and the rotor via the inlet for the crankcase gas. The crankcase gas enters the rotor from a central portion thereof. As the rotor rotates, the heavy constituents are separated therein and are propelled from an outer periphery of the rotor as droplets against an inner wall of the separation chamber. The droplets form the separated liquid phase which is led out of the centrifugal separator via the liquid outlet. The cleaned gas i.e., the crankcase gas relieved of its heavy constituents, is led out of the centrifugal separator via the gas outlet.

The centrifugal separator is configured for concurrent separation. That is, the separated phases travel in the same direction through the rotor of the centrifugal separator. More specifically, as discussed above, the liquid phase travels from the central portion of the rotor towards its periphery. So does the other separated phase i.e., the gas. It travels from the central portion of the rotor towards its periphery while the heavy constituents are separated therefrom and leaves the rotor at its periphery.

The rotor may comprise a number of separating members, which improve the separation of the heavy constituents from the crankcase gas. Such separating members may take the form of e.g., axially extending vanes which are directed radially from the rotor shaft or stacked frustoconical separation discs. As the rotor rotates, the heavy constituents are forced against surfaces of the separating members whereon they form droplets while traveling along the separation members towards the outer periphery of the rotor.

The housing of the centrifugal separator is stationary in relation to the ICE. The rotor shaft and the rotor are arranged to rotate in relation to the housing. The rotor shaft may be rotated by a driving member, such as a turbine wheel, an electric, pneumatic, or hydraulic motor, etc.

During operation of the centrifugal separator the axial direction may extend substantially vertically and the liquid outlet may be arranged at a lower end of the separation chamber. Thus, gravity may cause the droplets of the separated liquid phase flow along the inner walls of the separation chamber towards the liquid outlet.

During operation of the centrifugal separator, the sealing gap may form a gas tight seal or sealing the separation chamber from an adjacent space to the separation chamber. The gas tight seal is configured for a pressure difference commonly arising between a separation chamber of a crankcase gas centrifugal separator and an adjacent space thereof. In the adjacent space, a pressure of an ambient environment of the ICE may prevail or a pressure in between that of the pressure within the separation chamber and the ambient environment. That is, the pressure within the separation chamber is higher than the pressure of the ambient environment due to a pressure increase provided by the rotor during use of the centrifugal separator.

In the sealing gap, as the rotor rotates, a pumping effect may be achieved by the member connected to the rotor shaft. The pumping effect may assist in transporting the separated liquid phase through the sealing gap.

According to embodiments, the liquid outlet may be arranged 0-20 mm radially outside a radially outer ring surface of the bearing. In this manner, the liquid outlet may be arranged close to the bearing and accordingly, the sealing gap may be arranged close to the bearing and close to the rotor shaft. This may in turn provide for a small diameter sealing gap with a small friction creating surface close to the rotational axis thus, reducing frictional torque in comparison with a larger diameter sealing gap. Moreover, close manufacturing tolerances are more easily achieved at a small diameter than at a larger diameter.

According to embodiments, the liquid outlet may comprise a number of through holes extending through the housing and being arranged circumferentially around the bearing. In this manner, the separated liquid phase may flow out of the separation chamber at a number of circumferentially arranged positions. Thus, a circumferentially even draining of the separated liquid phase from the separation chamber may be ensured and stocking of liquid phase in a region remote from the liquid outlet may be avoided.

The liquid outlet may comprise at least two through holes, such as at least four, such as at least eight through holes.

The housing of the centrifugal separator may comprise a surrounding side wall, and a first and a second end wall, which enclose the separation chamber. The liquid outlet may be arranged in an end wall. Further, the end wall may comprise recesses for guiding separated liquid to the liquid outlet. As an example, the liquid outlet may comprise a number of through holes as discussed above, and an individual recess may be arranged radially outside at least one of the number of through holes, such as radially outside each through hole. A recess may be arranged such that its bottom surface is tilted radially inwards for guiding the separated liquid towards a respective through hole.

According to embodiments, at least one of the number of through holes may have a larger cross-sectional area at a distance from the separation chamber than close thereto. Thus, at least one through hole, such as all of the through holes, may have the form of a funnel with the narrow portion close to, or at, the separation chamber and its wider portion a distance from the separation chamber. In this manner, it may be ensured that the separated liquid phase will flow through the at least one through hole and that solid particles in the liquid phase entering the at least one through hole will not get stuck therein.

According to embodiments, each of the number of through holes may have a substantially circular or oval cross section. In this manner, the through holes of the number of through holes may be arranged close to the bearing and may be formed to provide the liquid outlet radially inside the radially outer end of the ring-shaped sealing gap while maintaining a small diameter ring-shaped sealing gap. Thus, the small diameter sealing gap advantages mentioned above, low frictional torque and close manufacturing tolerances, may be provided.

According to embodiments, a ring-shaped protrusion may be provided on the housing. An axial surface of the ring-shaped protrusion may form one surface defining the ring-shaped sealing gap and a surface of the member may form an opposite surface defining the ring-shaped sealing gap. In this manner, the sealing gap may be provided in a convenient manner between the housing and the member connected to the rotor shaft outside the separation chamber.

According to embodiments, the liquid outlet may be arranged to exit in the ring-shaped protrusion. In this manner, the separated liquid phase may be directed directly into the sealing gap and contribute to the sealing function of the sealing gap. Also, the separated liquid phase may be transported/pumped a shorter distance through the sealing gap than if the separated liquid phase where to be directed radially inside the sealing gap.

On the latter point, in comparison with the prior art as disclosed in WO 2016/198274, wherein the separated liquid phase is directed via the ball bearing to a radial position inside the sealing gap, by arranging the liquid outlet to exit in the ring-shaped protrusion, the separated liquid phase is supplied into the sealing gap in order to contribute to its sealing function while having a shorter distance for leave the sealing gap. Thus, the separated liquid phase is disposed of from the sealing gap efficiently.

According to embodiments, the ring-shaped sealing gap may form a labyrinth seal. In this manner, good sealing properties may be provided by the ring-shaped sealing gap. The labyrinth seal may be a single-stage labyrinth seal i.e., comprising only one directional change of the sealing gap, or it may be a multi-stage labyrinth seal i.e., comprising more than one directional change of the sealing gap. Such directional changes of the sealing gap may be between substantially radial and substantially axial directions in relation to the axial direction defined by the direction of the rotor shaft extending through the separation chamber.

According to embodiments, the centrifugal separator may comprise a driving chamber and a turbine wheel arranged in the driving chamber and connected to the end portion of the rotor shaft. The sealing gap may be provided in the driving chamber and may be configured to seal the driving chamber from the separation chamber. In this manner, the separation chamber may be sealed from the driving chamber outside the separation chamber in the driving chamber.

The turbine wheel may form the member, between which and the housing the sealing gap is formed. Alternatively, the member between which and the housing the sealing gap is formed may be a member separate from the turbine wheel.

According to embodiments, the separator rotor may comprise a stack of separation discs, each separation disc having a truncated conical shape. In this manner, efficient separation of the liquid phase from the crankcase gas may be ensured.

Between such separation discs arranged in a disc stack, interspaces are formed. As the rotor rotates with the disc stack, the heavy constituents are forced against the inner surfaces of the separation discs and form droplets as they travel along the separation discs towards an outer periphery of the disc stack.

According to embodiments, a ridge may extend around the bearing inside the separation chamber, radially between the bearing and the liquid outlet. The ridge may extend in the axial direction from the bearing into the separation chamber. In this manner, the ridge may prevent the separated liquid phase from reaching the bearing and thus, may prevent solid particles in the separated liquid phase from subjecting the bearing to wear.

According to embodiments, the ridge may comprise at least one opening. In this manner, a small amount of separated liquid phase may reach the bearing via the at least one opening. The at least one opening may have a circumferential extension that is less than half of the circumferential extension of the ridge, such as less than 25%, such as less than 10%, such as less than 5%, of the circumferential extension of the ridge. Thus, the bearing may be lubricated by the oil content of the liquid phase, but the ridge may still prevent a large amount of solid particles in the liquid phase from reaching the bearing.

According to embodiments, the bearing may be sealed towards the separation chamber. In this manner, any separated liquid phase reaching the bearing may be prevented from flowing through the bearing and thus, solid particles may be prevented from subjecting the bearing to wear.

Further features of, and advantages with, the invention will become apparent when studying the appended claims and the following detailed description.

### BRIEF DESCRIPTION OF THE DRAWINGS

Various aspects and/or embodiments of the invention, including its particular features and advantages, will be readily understood from the example embodiments discussed in the following detailed description and the accompanying drawings, in which:

FIG. 1 illustrates a cross section through a centrifugal separator according to embodiments,

FIGS. 2a and 2b illustrate a lower portion of a housing of a centrifugal separator according to embodiments, and

FIGS. 3-5 illustrate cross sections through lower portions of centrifugal separators according to various embodiments.

### DETAILED DESCRIPTION

Aspects and/or embodiments of the invention will now be described more fully. Like numbers refer to like elements throughout. Well-known functions or constructions will not necessarily be described in detail for brevity and/or clarity.

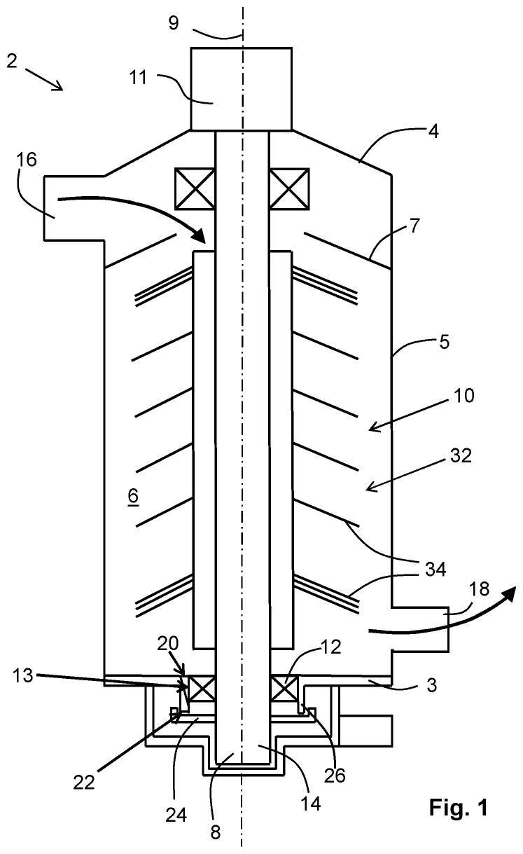

FIG. 1 illustrates a cross section through a centrifugal separator 2 according to embodiments. The centrifugal separator 2 is configured for separating a liquid phase from a crankcase gas coming from an internal combustion engine.

The centrifugal separator 2 comprises a housing 4, a separation chamber 6 inside the housing 4, a rotor shaft 8 extending through the separation chamber 6 in an axial direction, and a rotor 10 for separating the liquid phase arranged inside the separation chamber 6.

The housing 4 may be formed from one or more parts. The separation chamber 6 is delimited by at least part of the housing 4. For instance, the housing 4 may comprise a surrounding side wall 5, a first end wall 3 and an opposite second end wall 7, which enclose the separation chamber 6. The rotor 10 is connected to the rotor shaft 8.

A bearing 12 is arranged at an end portion 14 of the rotor shaft 8. The rotor shaft 8 is journalled in the housing 4 by the bearing 12. The bearing may be e.g., a ball bearing, a roller bearing, or a plain bearing. The rotor shaft 8 may be journaled in a further bearing at an opposite end portion of the rotor shaft 8.

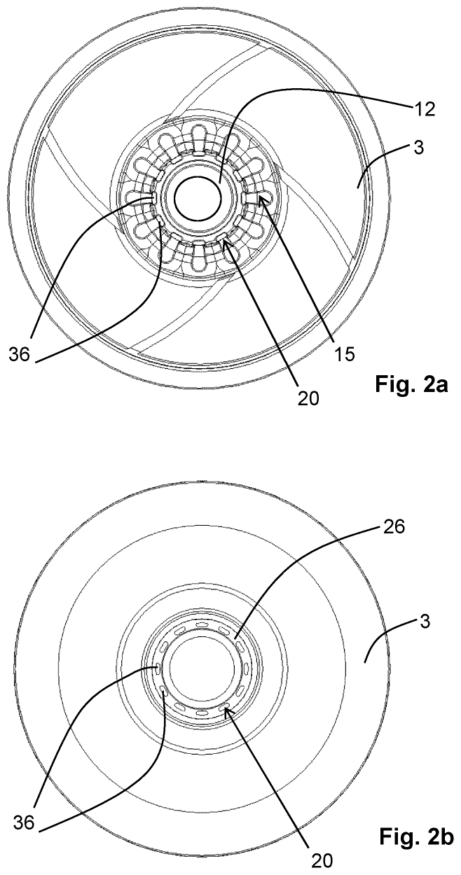

The centrifugal separator 2 further comprises an inlet 16 into the separation chamber 6 for the crankcase gas, a gas outlet 18 from the separation chamber 6 for separated gas, and a liquid outlet 20 from the separation chamber 6 for the separated liquid phase. In FIG. 1, the liquid outlet 20 is only indicated. The liquid outlet 20 is arranged in the first end wall 3 of the housing 4. Various embodiments of the liquid outlet 20 are shown in FIGS. 2a-5.

The end portion 14 of the rotor shaft 8 extends through the bearing 12 outside the separation chamber 6. A member 24 is connected to the rotor shaft 8 outside the separation chamber 6 at the end portion 14 of the rotor shaft 8.

A ring-shaped sealing gap 22 is formed between the housing 4 and a member 24 connected to the rotor shaft 8 outside the separation chamber 6, and the liquid outlet 20 is arranged, seen in relation to the axial direction, radially outside the bearing 12 and radially inside a radially outer end of the ring-shaped sealing gap 22.

A ring-shaped protrusion 26 is provided on the housing 4. An axial surface of the ring-shaped protrusion 26 forms one surface defining the ring-shaped sealing gap 22. A surface of the member 24 facing the axial surface of the ring-shaped protrusion 26 forms an opposite surface defining the ring-shaped sealing gap 22. That is, the sealing gap 22 is formed between the axial surface of the ring-shaped protrusion 26 and the surface of the member 24.

The separator rotor 10 comprises a stack 32 of separation discs 34, each separation disc 34 having a truncated conical, i.e. frustoconical, shape. Between the separation discs in the stack 32, interspaces are formed through which the crankcase gas travels from an inner periphery towards an outer periphery while being separated into the liquid and gas phases as the rotor 8 rotates. In FIG. 1 only some of the separation discs 34 are indicated.

In these embodiments the frustoconical separation discs 34 are stacked with their wide ends facing downwardly. In alternative embodiments, the frustoconical separation discs may be stacked with their wide ends facing upwardly.

Mentioned purely as examples, the rotor shaft 8 may have an outer diameter within a range of 8-14 mm, the bearing 12 may be a ball bearing having an inner diameter within a range of 8-14 mm, an outer diameter within a range of 18-36 mm, and a thickness/height within a range of 5-12 mm, the sealing gap 22 may have a width between the housing 4 and the member 24 within a range of 0.1-0.5 mm, and the number of separation discs 34 may be within the range of the 50-150, which may have an outer diameter within a range of 60-130 mm, and may be arranged at a distance within a range of 0.25-0.7 mm from each other.

The rotor shaft 8 is brought to rotate about a rotational axis 9 by a driving member. In the embodiments illustrated in FIG. 1, the drive member is an electric motor 11 connected to the rotor shaft 8.

The centrifugal separator 2 is configured to be positioned with the rotational axis 9 extending substantially vertical during use of the centrifugal separator 2. Accordingly, the liquid outlet is arranged at a lower end of the housing 4. The separated liquid phase may thus, be transported by gravity towards the liquid outlet 20.

FIGS. 2a and 2b illustrate an end wall 3 of the housing of a centrifugal separator according to embodiments, such as the centrifugal separator 2 shown in FIG. 1. FIG. 2a is a view showing the lower portion from an inside of the separation chamber 6 and FIG. 2b shows the lower portion in a view from outside the separation chamber.

In these embodiments, the liquid outlet 20 comprises a number of through holes 36 extending through the end wall 3 and being arranged circumferentially around the bearing 12. Thus, the separated liquid phase is evenly drained from the separation chamber around the bearing 12 via the number of through holes 36.

In these embodiments, each of the number of through holes 36 has a substantially oval cross section. Thus, the through holes 36 of the liquid outlet 20 may be arranged close to the bearing 12.

According to alternative embodiments, each of the through holes 36 may have a substantially circular cross-section, or a substantially rectangular cross-section or substantially square cross-section.

At least one of the number of through holes 36 may have a larger cross-sectional area at a distance from the separation chamber 6 than close thereto. That is, in the view shown in FIG. 2a, one or more of the through holes 36 has a smaller cross-sectional area than in the view shown in FIG. 2b. In this manner, it may be ensured that the separated liquid phase will flow through the through holes 36 and that any solid particles entering the through holes 36 will not get stuck in the through holes 36.

All of the through holes 36 may have a larger cross-sectional area at a distance from the separation chamber then close thereto.

The number of through holes 36 may more than two through holes 36, such as at least four through holes 36, such as within a range of 6-16 through holes 36, such as at least 10 through holes 36. In the illustrated example, the end wall 3 is provided with 12 through holes 36.

A total area of the liquid outlet 20 may be within a range of 18-75 mm² dived over the number of through holes 36. Mentioned as examples, an oval cross-section of a through hole may be 2×3.6 mm, a diameter of a circular cross-section though hole 36 may be 2 mm, a square cross-section trough hole 36 may measure 2×2 mm, and a rectangular cross-section trough hole 36 may measure 2×3.5 mm.

The end wall 3 comprises recesses 15 for guiding separated liquid to the liquid outlet 20. An individual recess 15 is arranged radially outside each of the through holes 36.

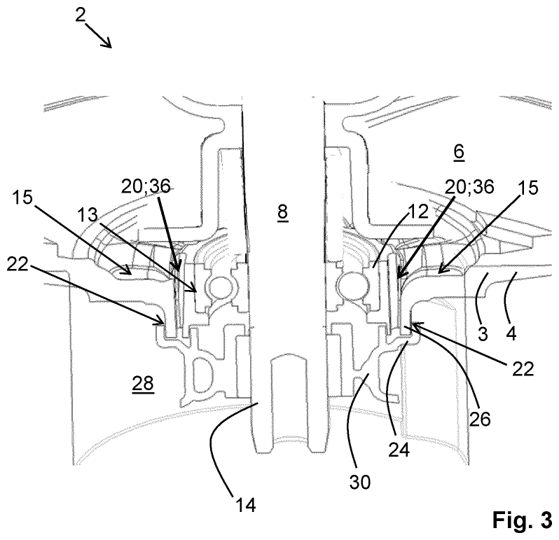

FIG. 3 illustrates a cross section through a lower portion of a centrifugal separator 2 according to embodiments. The centrifugal separator 2 is similar in many aspects to the centrifugal separator 2 discussed in connection with FIGS. 1-2b.

In these embodiments, the drive member arranged for rotating the rotor shaft 8 comprises a turbine wheel 30 instead of an electric motor. The turbine wheel 30 is configured to be driven by oil ejected onto shovels of the turbine wheel 30. For instance, engine oil of an ICE, the crankcase gas of which the centrifugal separator 2 is configured to clean, may be directed via a nozzle towards the turbine wheel 30.

Accordingly, the centrifugal separator 2 comprises a driving chamber 28 and a turbine wheel arranged in the driving chamber 28 and connected to the end portion 14 of the rotor shaft 8. The sealing gap 22 is provided in the driving chamber 28 and is configured to seal the driving chamber 28 from the separation chamber 6.

In these embodiments, the member 24, between which and the housing 4 the sealing gap 22 is formed, is constituted by the turbine wheel 30.

Again, a ring-shaped protrusion 26 is provided on the housing 4, and the sealing gap 22 is at least partially defined by two axially facing surfaces. An axial surface of the ring-shaped protrusion 26 and an opposite surface of the member 24/turbine wheel 30.

The liquid outlet 20 is arranged to exit in the ring-shaped protrusion 26. That is, the through holes 36 forming the liquid outlet 20 end in the ring-shaped protrusion 26 and thus, in the ring-shaped sealing gap 22. In this manner, the liquid phase flowing from the separation chamber 6 through the through holes 36 arrives in the ring-shaped sealing gap 22.

Again, the end wall 3 of the housing 4 comprises recesses 15 arranged radially outside the through holes 36 and configured for guiding separated liquid to the through holes 36.

FIG. 4 illustrates a cross section through a lower portion of a centrifugal separator 2 according to embodiments. The centrifugal separator 2 is similar in many aspects to one or more of the centrifugal separators 2 discussed in connection with FIGS. 1-3.

Again, the centrifugal separator 2 comprises a driving chamber 28 and a turbine wheel 30 connected to the end portion 14 of the rotor shaft 8. The turbine wheel 30 forms a driving member for rotating the rotor shaft 8 during operation of the centrifugal separator 2.

Again, an axial surface of a ring-shaped protrusion 26 of the housing 4 and an opposite surface define at least a portion of a ring-shaped sealing gap 22. In these embodiments, the opposite surface is provided by a member 24 separate from the turbine wheel 30. That is, the member 24 connected to the rotor shaft 8 is arranged between the turbine wheel 30 and the protrusion 26.

Again, the through holes 36 of the liquid outlet 20 are arranged to exit in the ring-shaped protrusion 26.

In FIG. 4 also the larger cross-sectional area of the through holes 36 at a distance from the separation chamber 6 than close thereto is clearly visible. That is, the funnel shape of the through holes 36 is shown in FIG. 4. For instance, one or more of the through holes 36 may have a conically widening cross section within a range of 0.5-5 degrees in a direction from the separation chamber 6 towards the ring-shaped sealing gap 22.

According to these embodiments, a ridge 38 extends around the bearing 12 inside the separation chamber 6, radially between the bearing 12 and the liquid outlet 20. The ridge 38 extends in the axial direction from the bearing 12 into the separation chamber 6. The ridge 38 may form part of the housing 4.

Thus, in addition to the liquid outlet being arranged radially outside the bearing 12 for draining separated liquid from the separation chamber at 6 before reaching the bearing 12, the ridge 38 prevents a main portion of a large gush of the separated liquid which might overflow the liquid outlet 20 from reaching the bearing 12. Accordingly, solid particles in the separated liquid phase may be prevented from reaching the bearing 12 in order to thus, prevent wear of the bearing 12.

The ridge 38 may have a height, h, within a range of 1-5 mm. In this manner, most expected large gushes of separated liquid phase may be prevented from reaching the bearing 12.

The height h of the ridge 38 extends in the axial direction, from a bottom surface of the separation chamber formed by the housing 4 into the separation chamber 6.

According to some embodiments, the ridge 38 may comprise at least one opening 40. In this manner, a small amount of separated liquid phase may reach the bearing via the openings 40. This small amount of separated liquid may lubricate the bearing 12.

Each of the at least one opening 40 may have a circumferential width within a range of 0.1-1 mm. In this manner, larger solid particles contained in the separated liquid phase may not flow through the opening 40 and may thus, be prevented from reaching the bearing and 12.

Mentioned as examples, the ridge 38 may be provided with one to six openings 40.

According to these embodiments, the at least one opening 40 may be provided in the form of a substantially vertically arranged slit in the ridge 38. In this manner, the at least one opening may be easily manufactured e.g. during injection moulding of a housing portion comprising the ridge 38.

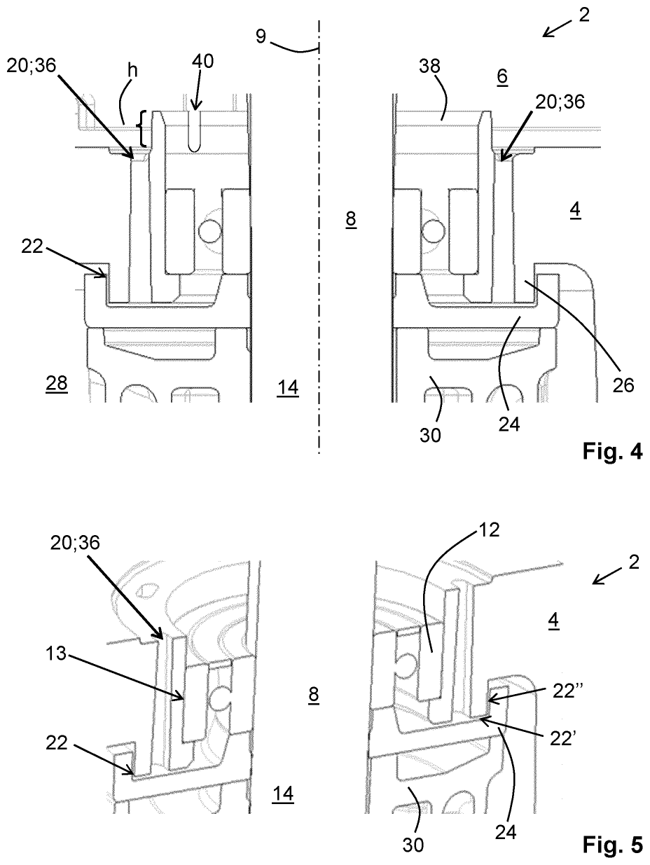

FIG. 5 illustrates a cross section through a lower portion of a centrifugal separator 2 according to embodiments. The centrifugal separator 2 is similar in many aspects to one or more of the centrifugal separators 2 discussed in connection with FIGS. 1-4.

Again, the centrifugal separator 2 comprises a driving chamber 28 and a turbine wheel 30 connected to the end portion 14 of the rotor shaft 8. The turbine wheel 30 forms a driving member for rotating the rotor shaft 8 during operation of the centrifugal separator 2.

Again, an axial surface of a ring-shaped protrusion 26 of the housing 4 and an opposite surface define by a member 24 delimit at least a portion of a ring-shaped sealing gap 22.

According to these embodiments, the bearing 12 is sealed towards the separation chamber 6. Thus, any separated liquid phase reaching the bearing 12 may be prevented from flowing through the bearing 12 and thus, solid particles may be prevented from subjecting the bearing 12 to wear.

In all embodiments of the centrifugal separator 2 discussed herein, inter alia with reference to FIGS. 1-5, the liquid outlet 20 may be arranged within a range of 0-20 mm radially outside a radially outer ring surface 13 of the bearing 12, see e.g. FIGS. 1, 3, and 5. That is, the through holes 36 forming the liquid outlet 20 may be arranged within a range of 0-20 mm radially outside a radially outer ring surface 13 of the bearing 12.

Again with reference to all embodiments, the ring-shaped sealing gap 22 may form a labyrinth seal. In the illustrated embodiments, a single-stage labyrinth seal i.e., comprising only one directional change between a radially extending portion 22′ to an axially extending portion 22″ of the sealing gap 22, as indicated in FIG. 5. However, multi-stage labyrinth seals i.e., comprising more than one directional change of the sealing gap may alternatively be provided.

However, according to alternative embodiments, in its simplest form, the sealing gap 22 may only extend in the radial direction or only in the axial direction.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

1. A centrifugal separator for separating a liquid phase from a crankcase gas, the centrifugal separator comprising:
a housing,
a separation chamber inside the housing,
a rotor shaft extending through the separation chamber in an axial direction,
a rotor for separating the liquid phase arranged inside the separation chamber, the rotor being connected to the rotor shaft;
a bearing arranged at an end portion of the rotor shaft,
an inlet for the crankcase gas;
a gas outlet from the separation chamber for separated gas; and
a liquid outlet from the separation chamber for the separated liquid phase, wherein the rotor shaft is journalled in the housing via the bearing,
wherein the end portion of the rotor shaft extends through the bearing outside the separation chamber,
wherein a ring-shaped sealing gap is formed between the housing and a member connected to the rotor shaft outside the separation chamber, and wherein the liquid outlet is arranged, seen in relation to the axial direction, radially outside the bearing and radially inside a radially outer end of the ring-shaped sealing gap.

2. The centrifugal separator according to claim 1, wherein the liquid outlet is arranged within a range of 0-20 mm radially outside a radially outer ring surface of the bearing.

3. The centrifugal separator according to claim 1, wherein the liquid outlet comprises a number of through holes extending through the housing and being arranged circumferentially around the bearing.

4. The centrifugal separator according to claim 3, wherein at least one of the number of through holes has a larger cross-sectional area at a distance from the separation chamber than close thereto.

5. The centrifugal separator according to claim 3, wherein each of the number of through holes has a substantially circular or oval cross section.

6. The centrifugal separator according to claim 1, wherein a ring-shaped protrusion is provided on the housing, an axial surface of the ring-shaped protrusion forming one surface defining the ring-shaped sealing gap and a surface of the member forming an opposite surface defining the ring-shaped sealing gap.

7. The centrifugal separator according to claim 6, wherein the liquid outlet is arranged to exit in the ring-shaped protrusion.

8. The centrifugal separator according to claim 6, wherein the ring-shaped sealing gap forms a labyrinth seal.

9. The centrifugal separator according to claim 6, comprising a driving chamber and a turbine wheel arranged in the driving chamber and connected to the end portion of the rotor shaft, wherein the sealing gap is provided in the driving chamber and is configured to seal the driving chamber from the separation chamber.

10. The centrifugal separator according to claim 1, wherein the separator rotor comprises a stack of separation discs, each separation disc having a truncated conical shape.

11. The centrifugal separator according to claim 1, wherein a ridge extends around the bearing inside the separation chamber, radially between the bearing and the liquid outlet, and wherein the ridge extends in the axial direction from the bearing into the separation chamber.

12. The centrifugal separator according to claim 11, wherein the ridge has a height within a range of 1-5 mm.

13. The centrifugal separator according to claim 11 or 12, wherein the ridge comprises at least one opening.

14. The centrifugal separator according to claim 13, wherein the at least one opening has a circumferential width within a range of 0.1-1 mm.

15. The centrifugal separator according to claim 13, wherein the at least one opening is provided in the form of a substantially vertically arranged slit in the ridge.

16. The centrifugal separator according to claim 2, wherein the liquid outlet comprises a number of through holes extending through the housing and being arranged circumferentially around the bearing.

17. The centrifugal separator according to claim 4, wherein each of the number of through holes has a substantially circular or oval cross section.

18. The centrifugal separator according to claim 2, wherein a ring-shaped protrusion is provided on the housing, an axial surface of the ring-shaped protrusion forming one surface defining the ring-shaped sealing gap and a surface of the member forming an opposite surface defining the ring-shaped sealing gap.

19. The centrifugal separator according to claim 3, wherein a ring-shaped protrusion is provided on the housing, an axial surface of the ring-shaped protrusion forming one surface defining the ring-shaped sealing gap and a surface of the member forming an opposite surface defining the ring-shaped sealing gap.

20. The centrifugal separator according to claim 4, wherein a ring-shaped protrusion is provided on the housing, an axial surface of the ring-shaped protrusion forming one surface defining the ring-shaped sealing gap and a surface of the member forming an opposite surface defining the ring-shaped sealing gap.
